(19) United States
(12) Patent Application Publication
(10) Pub. No.: US 2009/0066640 A1
(43) Pub. Date: Mar. 12, 2009

(54) DEVICE AND METHOD FOR PROVIDING A USER INTERFACE

(75) Inventors: Masanori Mitsugi, Kanagawa-ken (JP); Takashi Ashida, Kanagawa-ken (JP); Tomomi Inoue, Tokyo (JP)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 12/141,692

(22) Filed: Jun. 18, 2008

(30) Foreign Application Priority Data
Sep. 6, 2007 (JP) 2007-231748

(51) Int. Cl. G09G 5/00

(52) U.S. Cl. 345/156

(57) ABSTRACT

In an information processing apparatus, an operation receiving section receives an operation performed on a display. In response to the operation to call up a setting screen, a menu information generating section generates menu information in which a setting button requesting a setting conflicting with the current state is displayed in a highlighted mode. In response to the operation of pressing the highlighted setting button, an influence information generating section generates influence information on the current state conflicting with the setting to be made by pressing the setting button. In addition, a display control section controls the display of a setting screen, including the menu information, and also controls the display of a setting screen, including the influence information when the influence information is generated.

### CROSS-REFERENCE TO RELATED APPLICATIONS

This application claims priority under 35 U.S.C. § 119 to Japanese Patent Application No. 2007-231748 filed Sep. 6, 2007, the entire text of which is specifically incorporated by reference herein.

### TECHNICAL FIELD

The present invention relates to a device and a method for providing a user interface. In particular, the present invention relates to a device and a method that pertain to a user interface for making a certain setting.

### BACKGROUND

In order to cause an apparatus to perform a desired action, sometimes a user must set values respectively for a plurality of setting categories. This need often arises in the use of recent embedded apparatuses, especially so-called multifunction peripherals that incorporate a copy function, a printer function, a fax function and the like.

In general, a value is set for a setting category through a user interface. By enabling a user to set values respectively for a plurality of setting categories through a user interface, the user can be provided with flexible functionality. However, setting values respectively for the plurality of setting categories may require the user to perform complex operations.

Particularly, in the case of multifunction peripherals, setting values are strongly correlated with one another. For this reason, it is difficult to set values for a plurality of setting categories without causing any conflict therebetween, and this difficulty adversely affects the user interface.

In a current multifunction peripheral, a user can set a plurality of setting values, and the setting values are correlated with one another. This correlation sometimes leads to a scenario in which a setting value a for a setting category A conflicts with a setting value b for a setting category B. Since the two settings conflict, one of the settings must be given a higher priority over the other. Accordingly, the multifunction peripheral, through a user interface, must inform the user of the conflict between the two settings and of the need for judgment.

For example, the automatic paper-selection function and the automatic magnification-selection function conflict with each other. The automatic paper-selection function is a utility for choosing optimal printing paper on the basis of the size of the original paper and a set magnification. Accordingly, use of this function is based on the premise that a magnification is already defined, i.e., the automatic magnification-selection function is not chosen for use.

On the other hand, the automatic magnification-selection function is a utility for choosing an optimal magnification on the basis of the size of the original paper and the size of the printing paper. Accordingly, use of this function is based on the premise that the size of the printing paper is defined, i.e., the automatic paper-selection function is not chosen for use.

Hence, the user cannot concurrently choose both the automatic paper-selection function and the automatic magnification-selection function.

There are several conventional means for solving the above-described problem, and these means have been used to resolve conflicts among settings (see, e.g., Patent documents 1 and 2).

In Japanese Patent Application Laid-open Publication No. Hei 9-198191 (Patent document 1), when a signal for making a setting for image formation is inputted, an alarm display signal is outputted to display means for displaying settings that cannot be combined with the chosen setting.

In Japanese Patent Application Laid-open Publication No. 2005-94256 (Patent document 2), when multiple settings that conflict with one another are made, a display control means displays a notification that the made settings conflict with one another and also displays the reason why all of the made settings cannot be used concurrently. The display control means requires a user to choose between canceling one or more of the made settings and canceling all of the made settings.

However, the solving means disclosed in Patent documents 1 and 2 have the following problems.

In the solving means of Patent document 1, a user is merely informed of the settings that cannot be combined with the made setting. Hence, this method requires the user to perform additional operations in order to resolve conflicts among the settings.

In the solving means of Patent document 2, a user is merely permitted to choose between canceling one or more of the made settings and canceling all the made settings. Hence, this method does not permit the user to change original settings to other settings after canceling the original ones without taking additional steps.

### SUMMARY

An object of the present invention is to enable a user to make a setting conflicting with a current state of a device without having to perform any additional operation to change the current state.

To achieve the object, the present invention enables a user not only to make a setting conflicting with a current state of a device but also to change the current state. Specifically, the present invention comprises a device that provides a user interface. The device includes a display unit, a detection unit and a control unit. The display unit displays a screen as the user interface. The detection unit detects an operation on an object in the screen displayed by the display unit. When the detection unit detects an operation on a certain object in the screen displayed by the display unit, and when the operation on the certain object requires a first setting conflicting with a current state of the device, the control unit performs a control such that the display unit can display a first screen for changing the current state and for making the first setting.

In the device, the current state may be a state chosen from two states, and the first screen may be a screen for changing the current state to the other state of the two states and for choosing the first setting. Moreover, the first screen may include an object that gives, with a single operation, an instruction to change the current state and an instruction to make the first setting.

Alternatively, the current state may be a state chosen from three or more states, and the first screen may be a screen for changing the current state to a different state chosen from the three or more states by the user and for making the first setting. Moreover, the first screen may include a first object for choosing the different state and a second object for giving instructions to change the current state to the different state and to make the first setting.

In the device, when an operation on an object different from the certain object in the screen does not require a setting conflicting with the current state, the control unit may perform a control such that the display unit can display the certain object in a display mode that is distinct from the display mode for the different object.

In addition, when the operation on the certain object requires a second setting conflicting with multiple current settings of the device, the control unit may perform a control such that the display unit can display a second screen for collectively changing all of the conflicting current settings and for making the second setting.

The invention also provides a method for providing a user interface. The method includes the steps of: displaying an object in a screen as the user interface; detecting an operation on the displayed object; determining whether the operation on the object requires a certain setting conflicting with a current state; and displaying a certain screen for changing the current state and for making the certain setting, when the operation on the object is determined to require the certain setting.

Furthermore, the invention provides a program for enabling a computer to function as a device for providing a user interface. The program causes the computer to function as a display unit, a detection unit and a control unit. The display unit displays a screen as the user interface. The detection unit detects an operation on an object in the screen displayed by the display unit. When the detection unit detects an operation on a certain object in the screen displayed by the display unit, and when the operation on the certain object requires a certain setting conflicting with a current state of the device, the control unit performs a control such that the display unit can display a certain screen for changing the current state and for making the certain setting.

According to the present invention, a user is permitted to make a setting conflicting with a current state of a device without performing any additional operation for changing the current state.

### BRIEF DESCRIPTION OF THE DRAWINGS

Having thus described the invention in general terms, reference will now be made to the accompanying drawings, which are not necessarily drawn to scale, and wherein:

FIG. 1 shows menu information displayed in a setting screen according to an embodiment of the present invention.

FIG. 2 shows influence information displayed in the setting screen according to an embodiment of the invention.

FIG. 3 shows another setting value included in the influence information being chosen in the setting screen according to an embodiment of the invention.

FIG. 4 is a block diagram showing an example of a functional configuration of an information processing apparatus according to an embodiment of the invention.

FIG. 5 shows an example of setting information used in an embodiment of the invention.

FIG. 6 shows an example of conflict information used in an embodiment of the invention.

FIG. 7 is a flowchart showing an example of operations for displaying the menu information in an embodiment of the invention.

FIG. 8 is a flowchart showing an example of operations for displaying the influence information in an embodiment of the invention.

FIG. 9 shows a hardware configuration of a computer to which an embodiment of the invention is applicable.

### DETAILED DESCRIPTION

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A best mode for carrying out the present invention (hereinafter referred to as an exemplary “embodiment”) will be described below in detail with reference to the attached drawings.

Firstly, a detailed description will be given of a user interface employed in this embodiment, with examples of setting values.

Here, assume a scenario in which data scanned by using a multifunction peripheral is transmitted by e-mail. In this event, a user chooses values respectively for three setting categories. Specifically, a setting can be made for each of three setting categories—color mode selection, file format and sharpness—by choosing a setting value from the following options listed on the right below:
Color mode selection: “color”/“grayscale”/“black and white”
File format: “PDF”/“TIFF”/“JPEG”
Sharpness: “ON”/“OFF”

The combinations of setting values that conflict with one another are shown below:
Color mode selection: “black and white” conflicts with File format: “JPEG”
Color mode selection: “black and white” conflicts with Sharpness: “ON”

Assume a scenario in which a user first chooses “JPEG” for the file format setting category and “ON” for the sharpness setting category and subsequently proceeds to choose a setting value for the color mode selection setting category. Assume that the user previously had chosen the “color” setting value, and thus “color” is the current setting value for the color mode selection setting category.

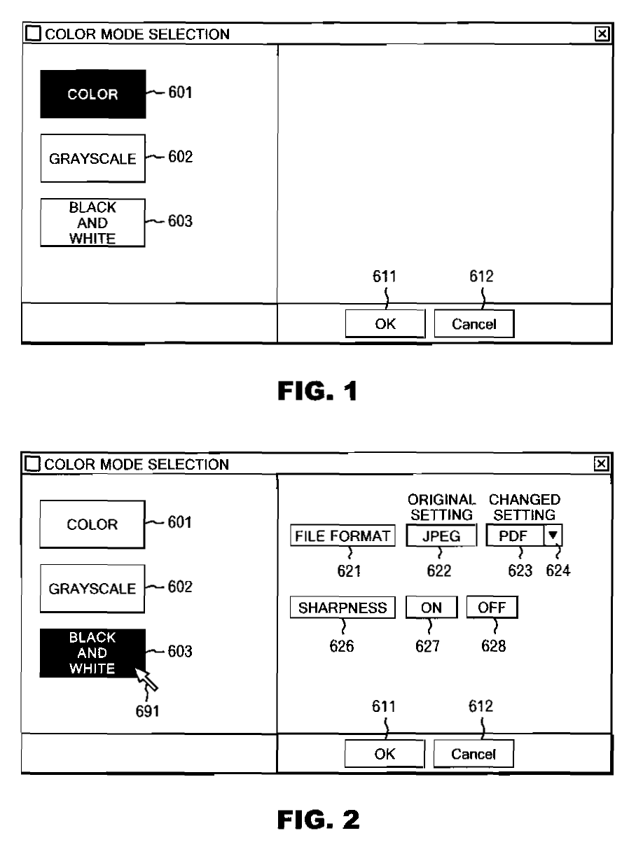

FIG. 1 shows an example of contents displayed in the color-mode-selection setting screen.

In this setting screen, a “color” button 601, a “grayscale” button 602 and a “black and white” button 603 are displayed on the left part. In addition, an “OK” button 611 and a “cancel” button 612 are displayed on the lower part. It should be noted that, in this embodiment, the buttons are examples of objects used in the display.

Among these buttons, the “black and white” button 603 is highlighted in the display, because the “black-and-white” setting value conflicts with current states of the device with respect to file format and sharpness—i.e., the “black and white” setting value conflicts with the current file format setting value and the current sharpness setting value. In the drawing, the highlight is expressed by shading.

This highlight permits the user to know in advance that at least one of the current setting values for the other setting categories—i.e., at least one of the current states with respect to the other setting categories—must be changed in order to enable the “black-and-white” setting value. Moreover, if the “black-and-white” setting value need not be chosen, the user merely chooses a different setting value, thus minimizing the number of interactions.

Since “color” is the current setting value for the color mode selection setting category, the “color” button 601 is displayed in a mode indicating that the “color” setting value is chosen, in FIG. 1. Here, this mode is expressed by the dark gray color.

In FIG. 1, the “grayscale” setting value is neither chosen nor in conflict with the current settings. Accordingly, the “grayscale” button 602 is displayed in the normal mode. Here, the normal mode is expressed by the light gray color.

In a case where the “black-and-white” setting value must be chosen in FIG. 1, the user presses the “black and white” button 603.

FIG. 2 shows an example of the contents displayed in the setting screen when the “black and white” button 603 is pressed.

When the “black and white” button 603 is pressed as shown by an arrow 691, the setting screen displays a list of any setting values for other setting categories that must be changed in order to enable the “black-and-white” setting value and also displays the new setting values that will take effect once the changes are made.

Specifically, a “file format” button 621, an original setting box 622 and a changed setting box 623 are displayed with respect to the file format setting category. Here, the original setting box 622 is a box for displaying a current setting value, and this box displays “JPEG.” The changed setting box 623 is a box for displaying a changed setting value, and this box displays “PDF.” More specifically, since the options for the changed setting value include “TIFF” as well as “PDF,” the changed setting box 623 is provided in the form of a pull-down menu. Hence, an arrow 624 for the pull-down menu is also displayed. In this embodiment, the arrow 624 for the pull-down menu is provided as an example of an object that facilitates choosing another state. It should be noted that although two options are provided in this embodiment, three or more options may be provided.

Moreover, with respect to the sharpness setting category, a “sharpness” button 626, an original setting box 627 and a changed setting box 628 are displayed. Here, the current setting value “ON” is displayed in the original setting box 627, and the changed setting value “OFF” is displayed in the changed setting box 628.

Hereinafter, the information displayed in a setting screen regarding setting values that must be changed is referred to as “influence information,” since such information pertains to other setting values that are influenced when a given setting value is chosen.

For instance, in FIG. 2, the display of influence information in the color-mode-selection setting screen enables the user to know the influence to be brought by the “black and white” setting value before confirming the choice of this setting value.

FIG. 2 shows that the current setting value for the sharpness setting category is “ON.” This setting value is changed to “OFF” when the “OK” button 611 is pressed in order to enable the “black and white” setting value. That is to say, the “OK” button 611 in this embodiment is an example of an object that provides instructions to change a current setting state and to make a certain setting with a single operation.

In FIG. 2, the current setting value for the file format setting category is “JPEG.” However, in order to enable the “black and white” setting value, the file format setting value must be either “PDF” or “TIFF.” Accordingly, in this embodiment, the user can manually choose to change the file format setting value to either “PDF” or “TIFF.”

FIG. 3 illustrates a state where the operation is performed for choosing another file format at this time.

In FIG. 3, instead of “PDF,” displayed as the initial setting value in the changed setting box 623, “TIFF,” displayed by pressing the arrow 624 for the pull-down menu, is chosen as the file format setting value, as shown by an arrow 692. Subsequently, the “OK” button 611 is pressed to enable the “black and white” setting value, and at the same time the file format setting value is changed to “TIFF.” The “OK” button 611 is an example of an object that gives instructions to choose a certain setting and to change the current setting state to another state.

With this configuration, a desired setting value can be chosen even when there are a plurality of setting value options apart from the currently chosen option.

An advanced setting screen may be provided for a setting category beyond the range covered by such a simple setting screen. For instance, by pressing the “file format” button 621 or the “sharpness” button 626, the setting screen can be switched to the related advanced setting screen.

As described above, this embodiment provides a more effective user interface for use when setting values are correlated. Concretely, this embodiment prevents conflict between setting values and enables a user to desirably make settings with the a minimal number of interactions by displaying both (1) an advance warning against conflict and (2) a setting-change-oriented influence range.

(1) Display of Advance Warning against Conflict

As shown in FIG. 1, a button for choosing a setting value that conflicts with the current setting values of other setting categories is displayed differently from buttons for choosing other setting values. In addition, when a user chooses a setting value that conflicts with the current setting values of other setting categories, the current setting values that conflict with the chosen setting value are displayed in order to allow the user to change these setting values. For these reasons, this embodiment places fewer restrictions upon operations than does the solving means of Patent document 1. To illustrate, in the solving means of Patent document 1, the user is merely allowed to make settings that do not conflict with the current settings, and thus operations that the user can perform are restricted. However, in this embodiment, operations that the user can perform are not so restricted.

### (2) Display of Setting-Change-Oriented Influence Range

As shown in FIG. 2, before the user chooses a setting value, the setting screen displays any conflicts upon other setting values that would result should the user choose that setting value and also provides a simple user interface for solving the conflict in the display. Displaying information before the setting value is confirmed enables the user to dynamically know the influence that will result from choosing that setting value. Moreover, through the simple user interface in the display, the user can choose the setting values necessary to perform a desired operation with a minimum number of interactions.

Next, a detailed description will be given of an apparatus for providing the user interface described above. The apparatus could be one of many options, including a multifunction peripheral. In this description, a general information processing apparatus 10 is employed as the apparatus for providing the above-described user interface.

First, a functional configuration of the information processing apparatus 10 will be described.

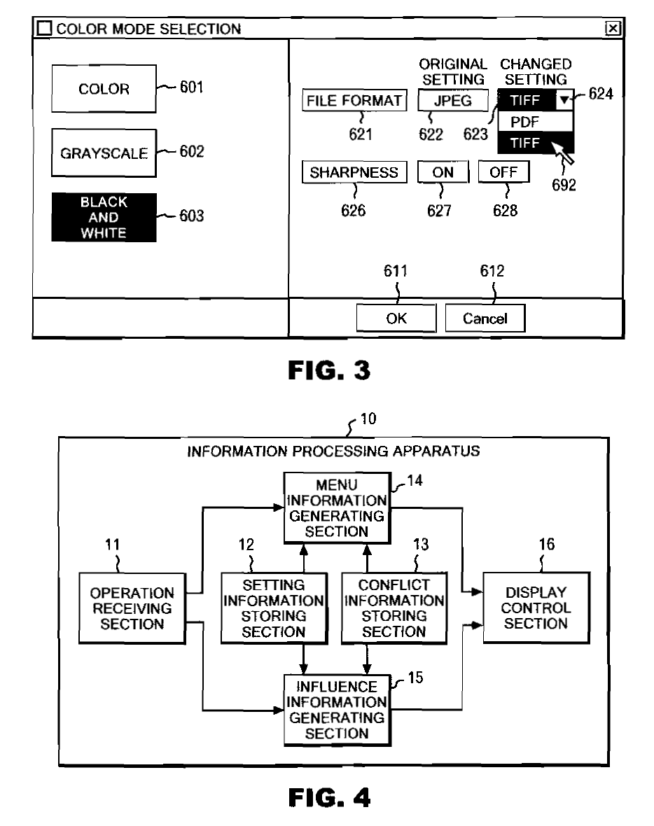

FIG. 4 is a block diagram illustrating an example of the functional configuration of the information processing apparatus 10.

As shown in FIG. 4, the information processing apparatus 10 includes an operation receiving section 11, a setting information storing section 12, a conflict information storing section 13, a menu information generating section 14, an influence information generating section 15 and a display control section 16.

The operation receiving section 11 receives the operation performed by the user on a display. In this embodiment, the operation receiving section 11 is provided as an example of a detection unit for detecting an operation of an object.

The setting information storing section 12 stores information indicating the setting value options for each setting category and also the setting values that are currently set (hereinafter referred to as “setting information”).

When there is a conflict between a setting value for one setting category and a setting value for another setting category, the conflict information storing section 13 stores information on the conflict (hereinafter referred to as “conflict information”). In this embodiment, a setting value is used as an example of a state of the apparatus. In other words, this embodiment is applicable even when there is a conflict between a setting value and a state of the apparatus.

The menu information generating section 14 generates menu information to be included in the setting screen based on the setting information stored in the setting information storing section 12. Moreover, the menu information generating section 14 determines the display mode for each button for making a setting (setting button) based on the conflict information stored in the conflict information storing section 13. In this embodiment, the menu information generating section 14 is provided as an example of a control unit for performing a control such that the display unit can display a certain object in a different mode from that for the other objects.

The influence information generating section 15 generates influence information based on the conflict information stored in the conflict information storing section 13. The influence information indicates any setting values that would conflict with a given setting value once such a setting value is chosen by the user. At the same time, the influence information generating section 15 also adds, to the generated influence information, information on setting values that are not currently chosen for each of the setting categories, in reference to the setting information stored in the setting information storing section 12. In this embodiment, the influence information generating section 15 is provided as an example of a control unit for performing a control such that the display unit can display a specific screen for both changing the current state and making a setting.

The display control section 16 controls display of the menu information generated by the menu information generating section 14 and the influence information generated by the influence information generating section 15. In this embodiment, the display control section 16 is provided as an example of a display unit for displaying screens.

Next, a description will be provided of the information stored in the setting information storing section 12.

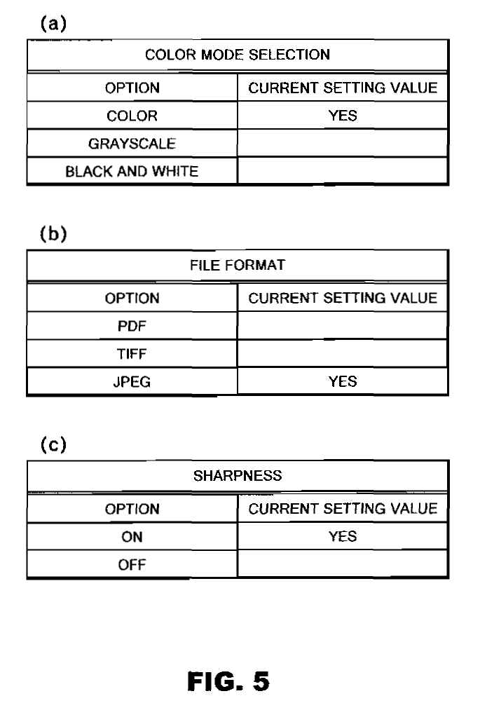

FIGS. 5A to 5C show examples of the setting information.

FIG. 5A shows an example of the setting information for the color mode selection setting category. “Color,” “grayscale” and “black and white” are the options for this setting category. FIG. 5A shows a case where “color” is chosen as the current setting value from these options.

FIG. 5B shows an example of the setting information for the file format setting category. “PDF,” “TIFF” and “JPEG” are the options for this setting category. FIG. 5B shows a case where “JPEG” is chosen as the current setting value from these options.

FIG. 5C shows an example of setting information for the sharpness setting category. “ON” and “OFF” are the options for this setting category. FIG. 5C shows a case where “ON” is chosen as the current setting value from these options.

Next, a description will be provided of the contents of conflict information stored in the conflict information storing section 13.

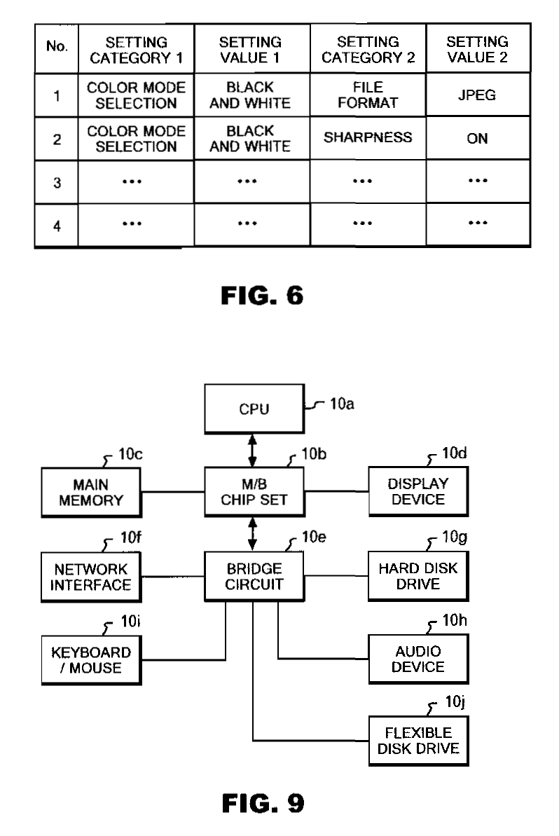

FIG. 6 shows an example of the conflict information. As shown in FIG. 6, conflict information includes an identification number, a setting category 1, a setting value 1, a setting category 2 and a setting value 2, all of which are associated with one another. Since conflict information consists of multiple records, identification numbers are provided respectively to the records to uniquely identify the individual records. Each of the records holds information on a combination of conflicting setting values of two different setting categories. In FIG. 6, the setting category 1 and the setting value 1 respectively denote one of the two setting categories and the setting value thereof, while the setting category 2 and the setting value 2 respectively denote the other setting category and the setting value thereof.

Specifically, a record No. 1 indicates that the setting value “black and white” of the color mode selection setting category conflicts with the setting value “JPEG” of the file format setting category. A record No. 2 indicates that the setting value “black and white” of the color mode selection setting category conflicts with the setting value “ON” of the sharpness setting category.

Next, a description will be provided of operations in this embodiment.

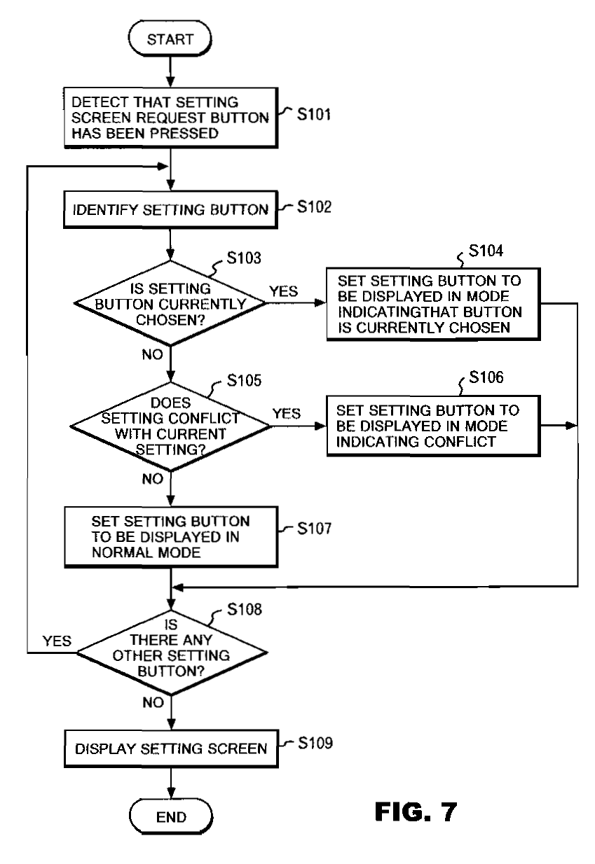

First, the operations that the information processing apparatus 10 performs when displaying the setting screen shown in FIG. 1 will be described. FIG. 7 is a flowchart showing an example of the operations. Before the operations start, a higher-order screen is assumed to be displayed to allow the user to make a request to display the setting screen of FIG. 1.

When the user presses a setting screen request button in the higher-order screen, the operation receiving section 11 receives the operation performed by the user and then notifies the menu information generating section 14 that the setting screen request button has been pressed (Step 101). Subsequently, the menu information generating section 14 performs the processing in Step 102 to Step 108 for each of the setting buttons included in the setting screen of FIG. 1.

Specifically, the menu information generating section 14 first identifies one of the setting buttons included in the setting screen (Step 102). For example, if a unique object ID is given to each button, the menu information generating section 14 only needs to identify the setting buttons through their object IDs.

Thereafter, the menu information generating section 14 refers to the setting information stored in the setting information storing section 12 and determines whether the setting button identified in Step 102 is currently chosen (Step 103). If it determines that the setting button is currently chosen, the menu information generating section 14 sets the setting button to be displayed in the mode indicating that the button is currently chosen (Step 104).

Otherwise, the menu information generating section 14 refers to the conflict information stored in the conflict information storing section 13 and determines whether the setting to be chosen by pressing the setting button identified in Step 102 conflicts with the current setting (Step 105). If it determines that the setting to be chosen by pressing the setting button conflicts with the current setting, the menu information generating section 14 sets the setting button to be displayed in the display mode indicating the conflict. Meanwhile, if it determines that the setting to be chosen by pressing the setting button does not conflict with the current setting, the menu information generating section 14 sets the setting button to be displayed in the normal display mode (Step 107).

Thereafter, the menu information generating section 14 determines whether there is another setting button (Step 108). If so, then the processing returns to Step 102, and the menu information generating section 14 performs the same processing for the next setting button. Once there is no other setting button, the menu information generating section 14 transmits the generated menu information to the display control section 16. Consequently, the display control section 16 displays the setting screen including the menu information (Step 109).

Next, a description will be provided of the operations performed by the information processing apparatus 10 when displaying the influence information on the right part of the setting screen of FIG. 1 as shown in FIG. 2.

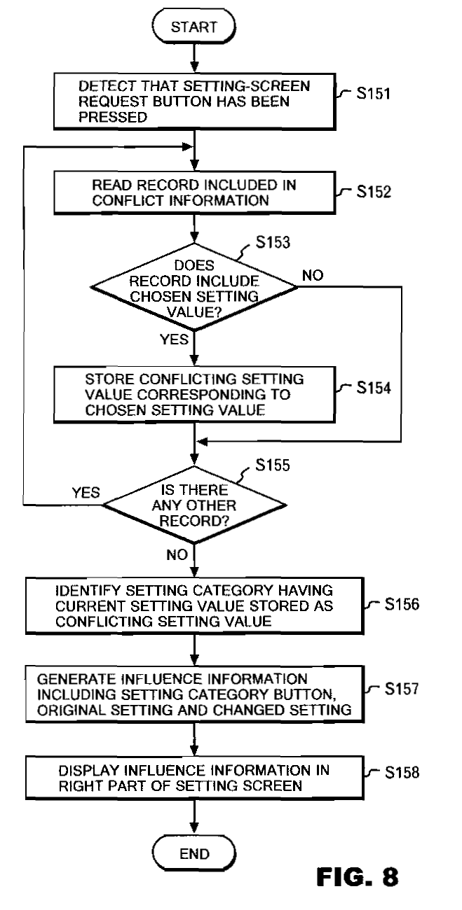

FIG. 8 is a flowchart showing an example of the operations. The setting screen of FIG. 1 is assumed to be displayed before the operations start.

When the user presses a setting button in the setting screen, the operation receiving section 11 receives the operation performed by the user and notifies the influence information generating section 15 that the button has been pressed (Step 151). Subsequently, the influence information generating section 15 performs the processing in Step 152 to Step 154 for each of the records included in the conflict information stored in the conflict information storing section 13.

Specifically, the influence information generating section 15 reads one of the records stored in the conflict information storing section 13 (Step 152). Then, the influence information generating section 15 determines whether the record includes the setting value (hereinafter referred to as a “chosen setting value”) indicated by the setting button detected as a pressed button in Step 151 (Step 153). Specifically, the influence information generating section 15 determines whether the combination of the setting category 1 and the setting value 1, or the combination of the setting category 2 and the setting value 2, indicates the chosen setting value.

If it determines that the record includes the chosen setting value, the influence information generating section 15 then stores the setting value included in the record as a setting value (hereinafter referred to as a “conflicting setting value”) that conflicts with the chosen setting value (Step 154). The conflicting setting values can be stored by marking options having the conflicting setting values among all the options for each of the setting categories. For example, in the case of reading the record No. 1 in FIG. 6, “YES” is written for “JPEG” among the setting values “PDF,” “TIFF” and “JPEG” in the file format setting category. In the case of reading the record No. 2 in FIG. 6, “YES” is written for “ON” among the setting values “ON” and “OFF” in the sharpness setting category.

On the other hand, if the influence information generating section 15 determines that the record does not include the chosen setting value, then the processing advances directly to Step 155.

Thereafter, the influence information generating section 15 judges whether there is any other record (Step 155). If so, the processing returns to Step 152, and the influence information generating section 15 performs the same processing for the next record. If there is no other record, the influence information generating section 15 searches the setting categories having the setting value options marked in Step 154 to identify a setting category having a currently chosen setting value (hereinafter referred to as a “current setting value”) thus marked (Step 156). For example, in the case where “YES” is written for the setting value “JPEG” in the file format setting category, and where the current setting value in the file format setting category is “JPEG,” the file format setting category is identified.

Then, for the identified setting category, the influence information generating section 15 generates the influence information, including a setting category button, an original setting and a changed setting (Step 157). The setting category button is a button that is labeled with the name of the setting category corresponding to the current setting value included in the records read in Step 152. For example, when the combination of a setting category 2 and the setting value 2 indicates the current setting value, the setting category 2 is set to be the label of the setting category button. Moreover, the current setting value is displayed as the original setting. For instance, when the combination of the setting category 2 and the setting value 2 indicates the current setting value, the setting value 2 is displayed as the original setting. Furthermore, a setting value that is an alternative to the current setting value and is selectable for the setting change is displayed as the changed setting. For example, when the combination of the setting category 2 and the setting value 2 indicates the current setting value, a setting value option not marked in Step 154 is displayed as the changed setting among the options of the setting category 2. Here, when only one option is displayed, the option is displayed in the form of the changed setting box 628 shown in FIG. 2. When two or more options are displayed, the options are displayed in the form of the changed setting box 623 shown in FIG. 2. Subsequently, the influence information generating section 15 transmits the generated influence information to the display control section 16, and the display control section 16 displays the influence information in the right part of the setting screen (Step 158).

In some scenarios, particular combinations of conflicting settings and current setting state cause all the setting value options to be marked in Step 154. In such scenarios, possible implementations include (1) displaying “unavailable category” as the changed setting, and (2) displaying the setting category button (such as the “file format” button 621 or the “sharpness” button 626) in a special mode without displaying anything as the changed setting. In both cases (1) and (2), the configuration is made so that the displayed screen cannot be switched to the advanced setting screen by pressing the setting category button.

In this embodiment, the problems in the solving means of Patent documents 1 and 2 can be solved by providing the above-described user interface. Solutions to these problems are specifically described below in the context of two scenarios.

### Scenario 1

In Scenario 1, assume a case where a user intends to choose the “black and white” setting value in the color-mode-selection setting screen. In this scenario, although the settings “file format: JPEG” and “sharpness: ON” are set in advance, the user is not aware of that.

In the solving means of Patent document 1, the “white and black” button is grayed out in the color-mode-selection setting screen and hence cannot be chosen. Accordingly, the following actions or the like are required:
1. Switch from the color-mode-selection setting screen by pressing the “cancel” button.
2. Move to the file format setting screen to change the setting from “JPEG” to “PDF” or “TIFF.”
3. Move to the sharpness setting screen to change the setting from “ON” to “OFF.”
4. Return to the color-mode-selection setting screen to choose “black and white.”

As described above, four different operations are required in the solving means of Patent document 1. Moreover, in this solving means, the user must be informed in other ways (e.g., through a displayed message or the like) that the file format and sharpness settings must be changed.

By contrast, in this embodiment, the user can make the same setting with a single operation of pressing the “black and white” button 603 of FIG. 1. In this embodiment, the user need not be informed by other means that the file format and sharpness settings must be changed.

In the solving means of Patent document 2, the “black and white” button is not grayed out in the color-mode-selection setting screen. In this scenario, selection of the “color mode selection: black and white” setting is made as follows:
1. When the user presses the “black and white” button, a dialog box prompting the user to choose among the options of canceling “color mode selection: black and white,” canceling “file format: JPEG,” canceling “sharpness: ON,” and canceling all the above (cancel all), is displayed.
2. Choose “cancel all” in the dialog box.
3. Make the setting “color mode selection: black and white” again (at this time, no dialog box is displayed).
   Alternatively, the following actions may be performed instead of the action “2”:
2′. Cancel “file format: JPEG” in the dialog box.
2″. Cancel “sharpness: ON” in the dialog box.
   When the “color mode selection: black and white” setting is chosen, the file format setting value “JPEG” conflicts with the “black and white” setting value and must be changed to either “PDF” or “TIFF.” However, the user cannot change the file format using the dialog box. Rather, to change the file format, the user must access the file format setting screen after making the color mode selection.

By contrast, in this embodiment, the user not only can choose the “color mode selection: black and white” setting but also can set a desired file format using the following steps:
1. Press the “black and white” button 603 in the setting screen, as shown in FIG. 1.
2. Choose “PDF” or “TIFF” using the same setting screen, as shown in FIG. 3.

### Scenario 2

Scenario 2 employs the following case. First, a user has already made the settings “file format: JPEG” and “sharpness: ON” and intends to give priority to these settings. However, when opening the color-mode-selection setting screen, the user finds the three options “color,” “grayscale” and “black and white.” The user chooses “black and white,” perhaps not realizing that the option “black and white” is not an available setting value.

In this scenario, in the solving means of Patent document 2, the following actions or the like are required:
1. When the user chooses the “black and white” option, a dialog box for allowing the user to choose one of the options for canceling “color mode selection: black and white,” canceling “file format: JPEG,” canceling “sharpness: ON,” and canceling all the above (cancel all), is displayed.
2. Cancel “color mode selection: black and white” in the dialog box.

By contrast, in this embodiment, the “black and white” option is highlighted in the color-mode-selection setting screen. Such highlighting permits the user to know in advance that choosing the “black and white” setting value requires changes in other setting values. Hence, an operational error can be prevented.

Lastly, a description will be given of a hardware configuration of a suitable computer for implementing this embodiment. FIG. 9 is a diagram showing an example of the hardware configuration of such a computer. As shown in the diagram, the computer includes: a central processing unit (CPU) 10a; a main memory 10c connected to the CPU 10a via a motherboard (M/B) chip set 10b; and a display device 10d connected to the CPU 10a via the M/B chip set 10b. In addition, a network interface 10f, a hard disk drive (HDD) 10g, an audio device 10h, a keyboard/mouse 10i and a flexible disk drive 10j are each connected to the M/B chip set 10b via a bridge circuit 10e.

In FIG. 9, the components are connected to each other via buses. For example, CPU buses are used to connect the CPU 10a and the M/B chip set 10b as well as the M/B chip set 10b and the main memory 10c. An accelerated graphics port (AGP) may be used to connect the M/B chip set 10b and the display device led. However, when the display device 10d includes a PCI-Express video card, a PCI Express (PCIe) bus is used to connect the M/B chip set 10b and the video card. In addition, a PCIe bus, for example, can be used to connect the network interface 10f and the bridge circuit 10e. A serial AT attachment (ATA) bus, a parallel ATA bus or a peripheral components interconnect (PCI) bus, for example, can be used to connect the HDD 10g and the bridge circuit 10e. A universal serial bus (USB) can be used to connect both the keyboard/mouse 10i and the flexible disk drive 10j to the bridge circuit 10e.

The present invention may be implemented by means of hardware alone or software alone. Alternatively, it is also possible to implement the present invention by means of both hardware and software. Moreover, the invention can be implemented as a computer, a data processing system or a computer program. If a computer program implementation is used, it can be stored in a computer-readable medium. Conceivable media for this purpose include a propagation medium and an electronic, magnetic, optical, electromagnetic, infrared or semiconductor system (device or equipment). Examples of a computer-readable memory include a semiconductor storage device, a solid-state storage device, a magnetic tape, a removable computer diskette, a random access memory (RAM), a read-only memory (ROM), a rigid magnetic disk and an optical disk. Currently known examples of optical disk include a compact disk read-only memory (CD-ROM), a compact disk read/write (CD-RW) and a digital versatile disc (DVD).

Hereinabove, the present invention has been described with the embodiment. However, the technical scope of the present invention is not limited to the above-described embodiment. It is obvious to those skilled in the art that various modifications and alternative embodiments can be employed without departing from the spirit and scope of the invention.

That which is claimed:

1. A device for providing a user interface, the device comprising:
a display unit for displaying a screen as the user interface;
a detection unit for detecting an operation on an object in the screen displayed by the display unit; and
a control unit for, when the detection unit detects an operation on a certain object in the screen displayed by the display unit, and when the operation on the certain object requires a first setting conflicting with a current state of the device, performing a control such that the display unit can display a first screen for changing the current state and for making the first setting.

2. The device according to claim 1, wherein
the current state is a state chosen from two states, and
the first screen is a screen for changing the current state to the other state of the two states and for making the first setting.

3. The device according to claim 2, wherein the first screen includes an object that gives, with a single operation, an instruction to change the current state and an instruction to make the first setting.

4. The device according to claim 1, wherein
the current state is a state chosen from three or more states, and
the first screen is a screen for changing the current state to a different state chosen from the three or more states and for making the first setting.

5. The device according to claim 4, wherein the first screen includes a first object for choosing the different state and a second object for giving instructions to change the current state to the different state and to make the first setting.

6. The device according to claim 1, wherein, when an operation on an object different from the certain object in the screen does not require a setting conflicting with the current state, the control unit performs a control such that the display unit can display the certain object in a display mode that is distinct from the display mode for the different object.

7. The device according to claim 1, wherein, when the operation on the certain object requires a second setting conflicting with multiple current settings of the device, the control unit performs a control such that the display unit can display a second screen for collectively changing all of the conflicting current settings and for making the second setting.

8. A method for providing a user interface, the method comprising the steps of:
displaying an object in a screen as the user interface;
detecting an operation on the displayed object;
determining whether the operation on the object requires a certain setting conflicting with a current state; and
displaying a certain screen for changing the current state and for making the certain setting when the operation on the object is determined to require the certain setting.

9. A program for enabling a computer to function as a device for providing a user interface, the program causing the computer to function as:
a display unit for displaying a screen as the user interface;
a detection unit for detecting an operation on an object in the screen displayed by the display unit; and
a control unit for, when the detection unit detects an operation on a certain object in the screen displayed by the display unit, and when the operation on the certain object requires a certain setting conflicting with a current state of the device, performing a control such that the display unit can display a certain screen for changing the current state and for making the certain setting.

10. The program according to claim 9, wherein
the current state is a state chosen from two states, and
the certain screen is a screen for changing the current state to the other state of the two states and for making the certain setting.

11. The program according to claim 9, wherein
the current state is a state chosen from three or more states, and
the certain screen is a screen for changing the current state to a different state chosen from the three or more states and for making the certain setting.
